(19) United States
(12) Patent Application Publication
(10) Pub. No.: US 2026/0210529 A1
(43) Pub. Date: Jul. 23, 2026

(54) INDICATOR LAMP ASSEMBLY, DOOR ASSEMBLY, AND DISHWASHER

(71) Applicant: WUHU MIDEA SMART KITCHEN APPLIANCE MANUFACTURING CO., LTD., Wuhu (CN)

(72) Inventors: Shuo ZHAO, Foshan (CN); Linfeng LIU, Foshan (CN)

(21) Appl. No.: 19/572,107

(22) Filed: Mar. 19, 2026

Related U.S. Application Data
(63) Continuation of application No. PCT/CN2024/106808, filed on Jul. 22, 2024.

(30) Foreign Application Priority Data
Sep. 28, 2023 (CN) 202311280852.6
Sep. 28, 2023 (CN) 202322666662.X

(51) Int. Cl. F21V 13/04; A47L 15/42; F21V 5/04; F21V 7/04; F21V 33/00; F21Y 113/17; F21Y 115/10

(52) U.S. Cl. CPC F21V 13/04; A47L 15/4257; A47L 15/4274; A47L 15/4293; F21V 5/048; F21V 7/043; F21V 33/0044; F21Y 2113/17; F21Y 2115/10

(57) ABSTRACT

An indicator lamp assembly includes a housing, a lamp source assembly, a convex lens, and a light guide pillar. The housing has a light guide cavity including a light inlet and a light outlet. An inner diameter of the light guide cavity gradually increases in a direction from the light inlet to the light outlet. The lamp source assembly includes a circuit board fixed to the housing and a lamp source mounted at the circuit board. The convex lens is fixed to the housing and disposed at the light outlet. The light guide pillar is fixed to the housing and located between the lamp source and the convex lens. The light guide pillar is configured to guide light emitted by the lamp source to the light inlet. A portion of the light is reflected by a cavity wall of the light guide cavity and further emitted to the convex lens.

### CROSS-REFERENCE TO RELATED APPLICATIONS

This application is a continuation of International Application No. PCT/CN2024/106808 filed on July 22, 2024, which claims priority to Chinese Patent Application Nos. 202311280852.6, and 202322666662.X, both filed on September 28, 2023 in the China National Intellectual Property Administration, the entire contents of all of which are incorporated herein by reference.

### TECHNICAL FIELD

The present disclosure relates to the technical field of household appliances, and in particular to an indicator lamp assembly, a door assembly, and a dishwasher.

### BACKGROUND

There are various types of household appliances, including, e.g., dishwashers, vegetable washers, disinfection cabinets, etc. Some household appliances are equipped with indicator lamps. The indicator lamps may be configured to indicate a working state of an electrical equipment. For example, when the household appliance is a dishwasher, information displayed by a display light spot projected by the indicator lamp on the ground may represent a working state of a body of the dishwasher, such as operation, pause, and the like.

However, in exemplary techniques, a display effect of the displayed light spot projected by the indicator lamp onto the illuminated surface is unsatisfactory.

### SUMMARY

Some embodiments of the present disclosure may provide an indicator lamp assembly, a door assembly, and a dishwasher.

In a first aspect, some embodiments of the present disclosure may provide an indicator lamp assembly. The indicator lamp assembly includes a housing, a lamp source assembly, a convex lens and a light guide pillar.

The housing has a light guide cavity. The light guide cavity includes a light inlet and a light outlet. An inner diameter of the light guide cavity gradually increases in a direction from the light inlet to the light outlet.

The lamp source assembly includes a circuit board fixed to the housing and a lamp source mounted at the circuit board. The convex lens is fixed to the housing and disposed at the light outlet. The light guide pillar is fixed to the housing and located between the lamp source and the convex lens.

The light guide pillar is configured to guide light emitted by the lamp source to the light inlet. A portion of the light is reflected by a cavity wall of the light guide cavity and further emitted to the convex lens.

In some embodiments, a contour of the light guide cavity may be configured as a frustum. An included angle between a central line of the light guide cavity and a contour line obtained by intersecting the light guide cavity with a cross-section passing through the central line of the light guide cavity may be greater than or equal to 10 degrees and less than or equal to 45 degrees.

In some embodiments, the light guide pillar may include a light emitting surface facing the light inlet. A spacing may be formed between the light emitting surface and the light inlet.

In some embodiments, the spacing may be less than or equal to 9 mm.

In some embodiments, the light guide pillar may include a light emitting surface facing the light inlet. A distance between the light emitting surface and a focal plane of the convex lens located on a side of the light inlet of the convex lens may be 20 mm to 50 mm.

In some embodiments, the housing further may have a mounting cavity in communication with the light guide cavity. The lamp source assembly and the light guide pillar may be fixed in the mounting cavity.

In some embodiments, the housing may include a housing body and a housing cover.

In some embodiments, the housing body may be hollow and may have the light guide cavity. The housing cover may cover an end of the housing body and cooperate with the housing body to have the mounting cavity.

In some embodiments, the housing further may have a wire hole in communication with the mounting cavity.

In some embodiments, the wire hole may be configured for a wire in communication with the circuit board to pass through.

In some embodiments, an outer side of the housing further may include a water block member arranged at an outer side of the housing.

In some embodiments, the water block member may be located above the wire hole.

In some embodiments, an outer side of the housing further may include a wire winding member.

In some embodiments, the wire winding member may be disposed adjacent to the wire hole.

In some embodiments, the light guide pillar further may include a light incident surface on an end in a length direction of the light guide pillar, a light emitting surface on another end in the length direction of the light guide pillar, and a peripheral surface. The peripheral surface may be connected between the light incident surface and the light emitting surface.

In some embodiments, a plurality of inclined surfaces may be formed on the peripheral surface. The plurality of inclined surfaces may be arranged at intervals in a peripheral direction of the light guide pillar. The plurality of inclined surfaces may extend from the light incident surface toward the light emitting surface.

In some embodiments, an end of each of the plurality of inclined surfaces facing the light incident surface may be disposed closer to a center of the light guide pillar than an end of each of the plurality of inclined surfaces facing the light emitting surface.

In some embodiments, the indicator lamp assembly may further include a fixation frame fixed to an outer periphery of the light guide pillar.

In some embodiments, the fixation frame may be connected to the housing and abut against the circuit board, and the circuit board may be fixed to the housing.

In some embodiments, the fixation frame may include a fixation plate and a plurality of support rods connected to the fixation plate.

In some embodiments, the plurality of support rods may be arranged around or surround an outer side of the light guide pillar. The fixation plate may be fixedly connected to the housing. The plurality of support rods may be configured to press the circuit board against the housing.

In some embodiments, the housing may further include a positioning column. The circuit board may have a positioning hole engaged with the positioning column.

In some embodiments, the indicator lamp assembly may further include a mounting bracket fixed to the housing.

In some embodiments, the convex lens may be mounted at the mounting bracket and cover the light outlet.

In some embodiments, the lamp source may be a multi-color LED light; and/or, the convex lens may be a double-convex lens.

In a second aspect, some embodiments of the present disclosure may provide a door assembly. The door assembly may include a door and the indicator lamp assembly as described above. A connection member may be arranged at an outer wall surface of the door. The housing may be configured with a mounting member. The mounting member may be fixedly connected to the connection member.

In some embodiments, the mounting member may be a slide buckle arranged at an outer side of the housing. The connection member may be a slide groove formed on the outer wall surface of the door.

The sliding buckle may be connected to the slide groove. The housing may be fixedly connected to the door.

In some embodiments, the sliding buckle may include a first sliding buckle, and the slide groove may include a first slide groove. The first sliding buckle may include an elastic arm and an engagement member. An end of the elastic arm may be connected to the outer side of the housing, and another end of the elastic arm may be connected to the engagement member. The elastic arm may be elastically deformable to enable the engagement member to be engaged into the first slide groove; and/or, the sliding buckle may include a second sliding buckle, and the slide groove may include a second slide groove. The second sliding buckle may include a connection section and an engagement section arranged at an angle to the connection section. An end of the connection section may be connected to the outer side of the housing, and another end of the connection section may be connected to the engagement section. The engagement section may be cooperatively engaged with the second slide groove. A number of the second sliding buckles may be two. A number of the second slide grooves may be two. Two adjacent engagement sections may extend away from each other along a length direction of the housing.

In a third aspect, some embodiments of the present disclosure may provide a dishwasher. The dishwasher includes a body and the door assembly as described above. The door is mounted at the body.

### BRIEF DESCRIPTION OF DRAWINGS

To describe the technical solutions in the embodiments of the present disclosure or in the related art more clearly, the following will briefly introduce the drawings required for describing the embodiments of the present disclosure or the related art. Evidently, the drawings in the following description are only some embodiments of the present disclosure. Those skilled in the art may further obtain other drawings without any creative work according to these drawings.

FIG. 1 is a schematic structural view of an indicator lamp according to some embodiments of the present disclosure.

FIG. 2 is a schematic cross-sectional view of the indicator lamp shown in FIG. 1.

FIG. 3 is a schematic structural view of the indicator lamp shown in FIG. 1 from another perspective.

FIG. 4 is an schematic exploded structural view of the indicator lamp shown in FIG. 1 from a perspective.

FIG. 5 is an schematic exploded structural view of the indicator lamp shown in FIG. 1 from another perspective.

FIG. 6 is an schematic exploded structural view of the indicator lamp shown in FIG. 1 from yet another perspective.

FIG. 7 is a schematic structural view of a door according to some embodiments of the present disclosure.

FIG. 8 is a schematic structural view of a door assembly according to some embodiments of the present disclosure.

Reference Numerals: 1: door assembly; 100: indicator lamp assembly; 10: housing; 10a: light guide cavity; 10b: light inlet; 10c: light outlet; 10d: mounting cavity; 10e: wire hole; 11: housing body; 110: mounting member; 111: wire winding member; 113: second sliding buckle; 1131: connection section; 1133: engagement section; 115: positioning column; 13: housing cover; 131: stop rib; 133: water block member; 135: first sliding buckle; 1351: elastic arm; 1353: engagement member; 30: lamp source assembly; 31: circuit board; 31a: positioning hole; 33: lamp source; 331: light; 50: mounting bracket; 70: convex lens; 71: double-convex lens; 80: fixation frame; 81: fixation plate; 83: support rod; 90: light guide pillar; 91: light incident surface; 93: light emitting surface; 95: peripheral surface; 97: inclined surface; 200: door; 210: connection member; 235: first slide groove; 213: second slide groove; L1: contour line; L2: central line; L3: spacing.

The achievement of objectives, functional features, and advantages of the present disclosure will be further explained with reference to the accompanying drawings in conjunction with the embodiments.

### DETAILED DESCRIPTION

To make the purpose, technical solutions, and advantages of the present disclosure clearer, the following sections will provide a detailed description of the embodiments of the present disclosure in conjunction with the accompanying drawings.

In the following description, unless otherwise indicated, the same reference numerals refer to the same or similar elements in different drawings. The embodiments described in the following exemplary embodiments do not represent all embodiments consistent with the present disclosure. On the contrary, they are merely examples of devices and methods consistent with some aspects of the present disclosure as detailed in the appended claims.

In the description of the present disclosure, it is understood that terms such as “first,” “second,” etc. are solely for descriptive purposes and should not be understood as indicating or implying relative importance. For those skilled in the art, the specific meanings of the above terms in the present disclosure may be understood based on the specific circumstances. Furthermore, unless otherwise specified in the description of the present disclosure, “multiple” refers to two or more. “And/or” describes a relationship between associated objects, indicating that three relationships may exist, for example, A and/or B may indicate: A exists alone, A and B exist together, or B exists alone. The character “/” generally indicates that the associated objects before and after it are in an “or” relationship.

Unless otherwise formed, all technical and scientific terms mentioned in this specification have the same meanings as those generally understood by those skilled in the art. The terms mentioned in this specification are intended solely to describe specific embodiments and are not intended to limit the scope of the present disclosure. The term “and/or” used herein includes any one and all combinations of one or more of the listed items.

Currently, a household appliance may include a device body and an indicator lamp. A working state of the device body may be indicated by the indicator lamp. For example, when the household appliance is a dishwasher, information displayed by a display light spot projected by the indicator lamp on the ground may represent a working state of a body of the dishwasher, such as operation, pause, and the like.

However, in some examples, a display effect of the displayed light spot projected by the indicator lamp onto an illuminated surface is poor. For example, the overall brightness of the displayed light spot projected on the ground is uneven, resulting in a poor indication effect of the indicator lamp, thereby affecting the user experience.

To solve the above problems, an aspect of the present disclosure provides a dishwasher. In some embodiments of the present disclosure, the dishwasher includes a body and a door assembly 1.

The body may include a washing cavity or chamber and have an opening in communication with the washing cavity. The washing cavity may be a cavity configured to place or accommodate a tableware. The opening may be configured to allow a user to load or unload the tableware. The door assembly 1 may be mounted at the body. In some embodiments, the door assembly 1 may be mounted at the opening of the body and capable of being opened and closed. The door assembly 1 may be configured to open/uncover or close/cover the opening.

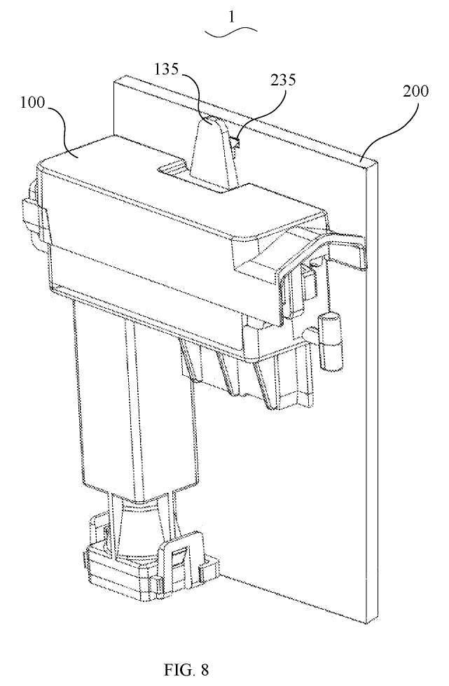

Another aspect of the present disclosure provides a door assembly 1. As shown in FIG. 8, in some embodiments of the present disclosure, the door assembly 1 includes a door 200 and an indicator lamp assembly 100.

The door 200 may be mounted at the body. In some embodiments, the door 200 may be mounted at the opening of the body and capable of being opened and closed. The door 200 may be configured to uncover the opening or cover the opening.

The indicator lamp assembly 100 may be fixedly connected to the door 200. For example, the indicator lamp assembly 100 may be fixedly connected to an outer wall surface of the door 200. It may be understood that, in actual use, the outer wall surface of the door 200 may be a wall surface of the door 200 facing the user. The outer wall surface of the door 200 may be configured with a connection member 210. Correspondingly, the indicator lamp assembly 100 may be configured with a mounting member 110. The mounting member 110 may be fixedly connected to the connection member 210, so that the indicator lamp assembly 100 may be fixedly connected to the door 200. Of course, the indicator lamp assembly 100 may also be connected to the door 200 through bonding or other connection forms, which is not limited in the present disclosure.

The indicator lamp assembly 100 may be electrically connected to the body of the dishwasher. For example, the indicator lamp assembly 100 may be electrically connected to the body through a wire. Thus, the indicator lamp assembly 100 may project a displayed light spot onto a ground on the exterior of the dishwasher or outside the dishwasher, and indicate an operating state of the dishwasher through a display state of the displayed light spot. For example, in a case where the working state of the dishwasher is an operating state, the indicator lamp assembly 100 may project a displayed light spot with a warm color on the ground, for example, project a displayed light spot with a color of red or orange on the ground. In a case where the working state of the dishwasher is an idle state, the indicator lamp assembly 100 may project a displayed light spot with a cold color on the ground, for example, project a displayed light spot with a color of blue or green on the ground.

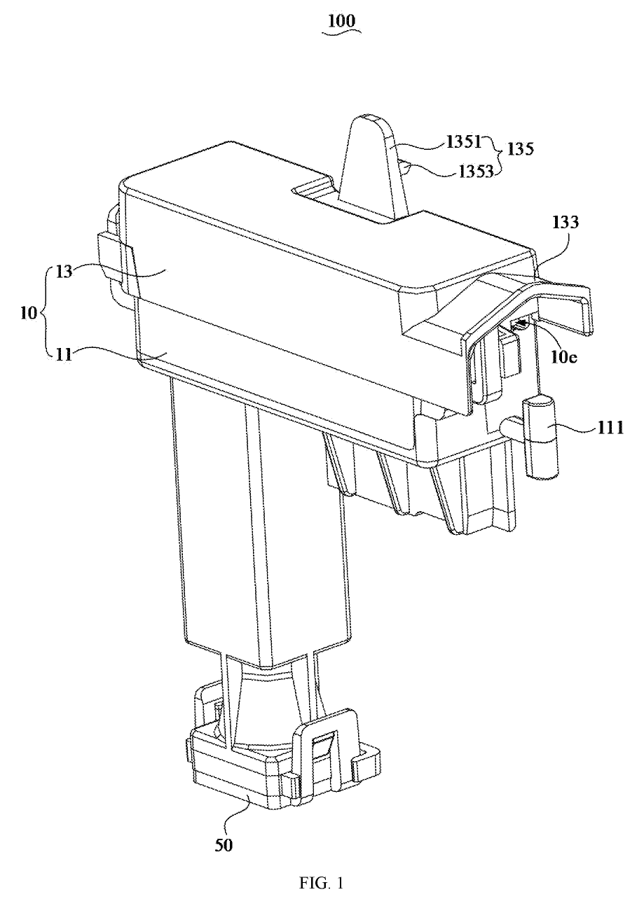

In actual use, in order to reduce the occurrence of inability of obtaining the current working state of the body from the displayed light spot due to the poor display effect of the displayed light spot projected by the indicator lamp assembly 100, the displayed light spot of the present disclosure may focus on improvement of the indicator lamp assembly 100. As shown in FIGS. 1 to 3, in some embodiments of the present disclosure, the indicator lamp assembly 100 may include a housing 10, a lamp source assembly 30, a convex lens 70, and a light guide pillar/column/pole 90. The lamp source assembly 30, the convex lens 70, and the light guide pillar 90 may be fixed to the housing 10. The light guide pillar 90 may be located between the lamp source assembly 30 and the convex lens 70.

The housing 10 may have an outer contour substantially of a rectangular prism, a cube, or formed by a combination of multiple rectangles, thereby having multiple outer walls. The shape of the housing 10 is not limited in the present disclosure. A main structure of the housing 10 may be made of non-light-transmitting material, such as a metal material or other non-light-transmitting plastic materials, which is not limited in the present disclosure. The housing 10 may be fixedly connected to the door 200. That is, the mounting member 110 may be arranged at the housing 10, so that the housing 10 may be fixedly connected to the door 200 through the fixed connection between the mounting member 110 and the connection member 210.

The housing 10 may be hollow and have a mounting cavity 10d and a light guide cavity 10a. The lamp source assembly 30 and the light guide pillar 90 may be fixed in the mounting cavity 10d, thereby being fixed to the housing 10. The light guide cavity 10a may be in communication with the mounting cavity 10d. The light guide cavity 10a may include a light inlet 10b and a light outlet 10c. It can be understood that, in other structural forms, the housing 10 may only have the light guide cavity 10a, and the lamp source assembly 30 and the light guide pillar 90 may be directly fixed to the housing 10 via connecting members. It should be noted that a shape of the displayed light spot may be adapted to or fitted with a shape of the convex lens 70, and a shape of the light outlet 10c may be adapted to or fitted with the shape of the convex lens 70. For example, in a case where the convex lens 70 is circular, the shape of the light outlet 10c may also be circular. After a light 331 passes through the convex lens 70 and is emitted out of the light outlet 10c, the shape of the displayed light spot finally presented on the ground may be circular.

The lamp source assembly 30 may have a function of emitting the light 331. The lamp source assembly 30 may include a circuit board 31 and a lamp source 33 mounted at the circuit board 31. The circuit board 31 may be fixed to the housing 10, that is, the circuit board 31 may be fixed in the mounting cavity 10d. The lamp source 33 may be configured to emit the light 331. The housing 10 may have a wire hole 10e, and the wire hole 10e may be in communication with the mounting cavity 10d. The wire hole 10e may allow a wire connected to the circuit board 31 to pass through. In a case where the lamp source assembly 30 is fixed to the door 200, the circuit board 31 may be electrically connected to a main control module of the body through the wire. Thus, the main control module of the body may output a signal to the circuit board 31 of the indicator lamp assembly 100 according to a current state of the body. The circuit board 31 may drive the lamp source 33 to emit the light 331 of a corresponding color, thereby achieving an effect of automatically emitting the light 331 by the lamp source 33.

In some embodiments, the lamp source 33 may be a single-color LED light or a multi-color LED light. In a case where the lamp source 33 is a multi-color LED light, the lamp source 33 may emit the light 331 of multiple colors through combined color mixing. For example, when the multi-color LED light includes three LED beads, the three LED beads may emit the light 331 of red, green, and blue colors respectively. Red, green, and blue are the three primary colors in the optical system. Therefore, the lamp source 33 may not only emit the light of three different colors such as red, green, and blue, but also adjust the light intensity of different colors of the light 331 by mixing the light of two or three colors of red, green, and blue. In this way, the light 331 of different colors may be mixed. Of course, the multi-color LED light may also include four LED beads, and the four LED beads may emit the light 331 of red, green, blue, and white colors, which is not limited in the present disclosure.

Therefore, in a case where the lamp source 33 is a multi-color LED light, the lamp source 33 may emit the light 331 of more different colors to finally present the displayed light spots of multiple different colors. Therefore, the indicator lamp assembly 100 may indicate more working states of the body. Besides, the users may also select the displayed color of the displayed light spot according to their own preferences. In this way, the needs of different users may be met. The following content will take the lamp source 33 as a multi-color LED light as an example to further illustrate the content of the present disclosure.

The convex lens 70 may be disposed at the light outlet 10c of the light guide cavity 10a and configured to converge the light 331. The convex lens 70 may be made of transparent plastic material. For example, suitable exemplary materials that may be used include, but are not limited to, PMMA (Polymethyl Methacrylate), PC (Polycarbonate), ABS (Acrylonitrile Butadiene Styrene plastic). Of course, the convex lens 70 may also be made of optical glass, which is not limited in the present disclosure. In the actual emission process of the light 331, under the guidance of the light guide pillar 90, the light 331 emitted by the lamp source assembly 30 may be guided by the light guide pillar 90 to the entrance of the light guide cavity 10a. After the light 331 passes through the light guide cavity 10a, the light 331 may be exited from the exit of the light guide cavity 10a. Finally, the light 331 may be gathered or focused by the convex lens 70 to present a high-brightness displayed light spot on the ground.

The convex lens 70 may be a double-convex lens 71 or a plano-convex lens. In a case where the convex lens 70 is a double-convex lens 71, the light 331 may be effectively refracted and better gathered, thereby forming a high-brightness displayed light spot and improving the display effect of the displayed light spot.

The light guide pillar 90 may be cylindrical and located between the lamp source 33 of the lamp source assembly 30 and the convex lens 70. The light guide pillar 90 may include a light incident surface 91 at an end in the length direction of the light guide pillar 90 and a light emitting surface 93 at another end in the length direction of the light guide pillar 90, and a peripheral surface 95. The peripheral surface 95 may be connected between the light incident surface 91 and the light emitting surface 93. The light emitting surface 93 may face the light inlet 10b. A main structure of the light guide pillar 90 may be made of transparent plastic material. For example, suitable exemplary materials that may be used include, but are not limited to, PMMA (Polymethyl Methacrylate) material, PC (Polycarbonate) material, ABS (Acrylonitrile Butadiene Styrene plastic) material. Of course, the main structure of the light guide pillar 90 may also be made of optical glass, which is not limited in the present disclosure.

The light guide pillar 90 may be configured to guide the light 331. The light guide pillar 90 may be configured to guide the light 331 emitted by the lamp source 33 to the light inlet 10b of the light guide cavity 10a. That is, after the light 331 emitted by the lamp source 33 is incident on the light incident surface 91 and enters the interior of the light guide pillar 90, the light 331 may be guided inside the light guide pillar 90 and emitted from the light emitting surface, and finally the light 331 may be directed to the light inlet 10b of the light guide cavity 10a. Thus, most of the light 331 emitted by the lamp source 33 may be guided by the light guide pillar 90 to be transmitted from the lamp source 33 to the light inlet 10b of the light guide cavity 10a with minimal loss, thereby reducing the loss of the light 331. In this way, the displayed light spot presented on the ground may have uniform brightness. Moreover, in a case where the lamp source 33 emits the light 331 of multiple different colors, the light 331 of multiple different colors may undergo multiple total reflections inside the light guide pillar 90. That is, the light 331 may be reflected by the peripheral surface 95, thereby achieving a uniform color mixing effect, so that the color of the final displayed light spot is uniform, facilitating the user to clearly understand the color presented by the displayed light spot and clearly obtain the current working state of the body.

During the processing of the light guide pillar 90, an inner peripheral surface of the peripheral surface 95 may have a certain surface roughness. As a result, when the light 331 is exited through the light emitting surface 93, a portion of the light 331 may be emitted into the light guide cavity 10a in a direction perpendicular to the light emitting surface 93. Another portion of the light 331 may be emitted in a direction intersecting with the direction perpendicular to the light emitting surface 93. The direction intersecting the direction perpendicular to the light emitting surface 93 may be arranged at an angle to the direction perpendicular to the light-emitting surface 93. Thus, in a case where the another portion of the light 331 is projected onto the ground, the overall area of the displayed light spot may become too large and too dispersed, resulting in a reduced brightness of the displayed light spot and affecting the display effect.

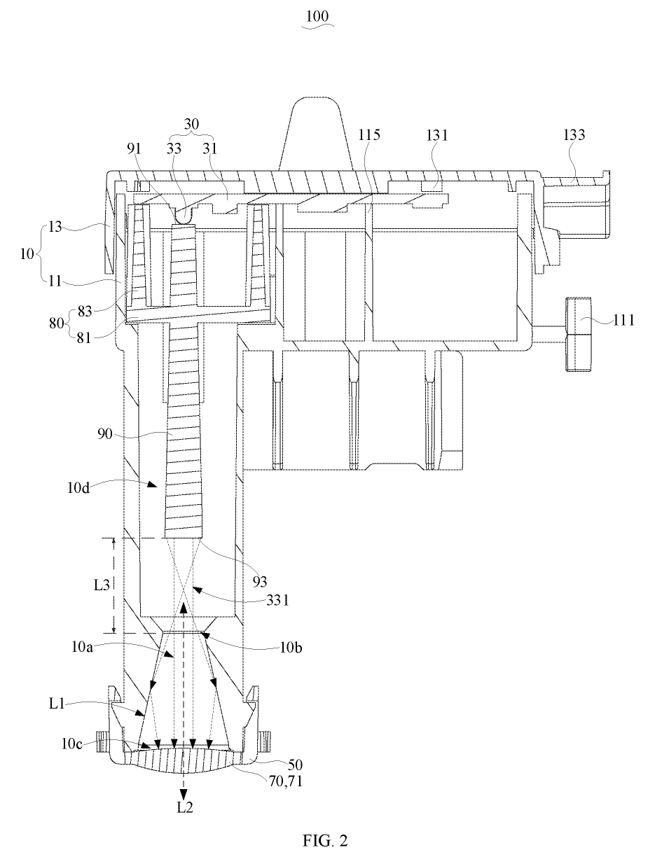

Regarding the above issues, as shown in FIG. 2, the inner diameter of the light guide cavity 10a may be arranged to gradually increase in the direction from the light inlet 10b to the light outlet 10c. In this way, the direction of the light 331, which is exited in the direction intersecting with the direction perpendicular to the light emitting surface 93, emitted to the convex lens 70 may be changed under the reflection of the cavity wall of the light guide cavity 10a. Therefore, the light 331 emitted from the light guide pillar 90 may be more converged and uniformly projected onto the convex lens 70, and the light 331 may be converged by the convex lens 70 and mapped onto the same range on the ground, thereby achieving improvement of display effect. Further, in order to improve the reflectivity of the cavity wall of the light guide cavity 10a, in some embodiments of the present disclosure, a reflective film layer may also be attached on the cavity wall of the light guide cavity 10a, or polishing treatment may be performed on the cavity wall of the light guide cavity 10a, to improve the reflectivity of the cavity wall of the light guide cavity 10a.

The technical solution of some embodiments of the present disclosure, by configuring the light guide pillar 90 and the convex lens 70 in the indicator lamp assembly 100 and arranging the light guide pillar 90 between the lamp source 33 and the convex lens 70, may enable the light 331 emitted by the lamp source 33 to be guided by the light guide pillar 90 and transmitted from the lamp source 33 to the convex lens 70 with minimal loss, thereby reducing the loss of the light 331 during the transmission. Therefore, the displayed light spot presented on the ground may have uniform overall brightness, and the display effect may be improved.

Besides, in some embodiments of the present disclosure, the light guide cavity 10a may be further formed in the housing 10. After the light 331 guided by the light guide pillar 90 enters the entrance of the light guide cavity 10a, a portion of the light 331 may be reflected by the cavity wall of the light guide cavity 10a and further transmitted to the convex lens 70. In this way, the light 331 emitted from the light guide pillar 90 may be more converged and uniformly projected onto the convex lens 70. In a case where the size of the light spot emitted from the convex lens 70 meets usage requirements, the light 331 emitted from the light guide pillar 90 may be converged by the convex lens 70 and mapped onto the same range on the ground, thereby presenting a light spot effect with uniform brightness, achieving a significant improvement in the display effect, and making it more convenient for the users to observe.

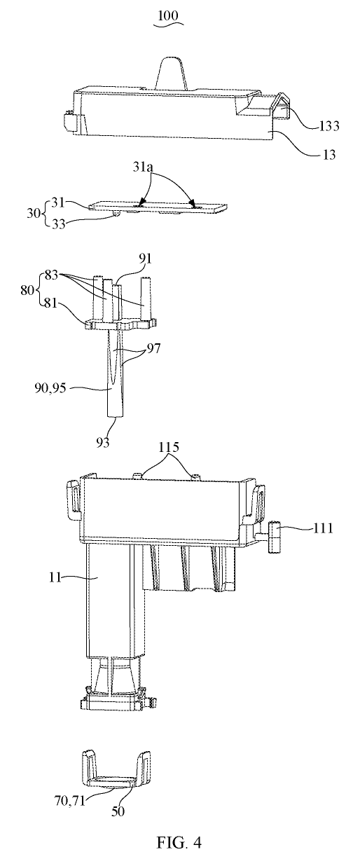

In some embodiments, as shown in FIGS. 2 and 4, a contour of the light guide cavity 10a may be frustoconical. A cross-sectional area of the light inlet 10b of the light guide cavity 10a may be smaller than a cross-sectional area of the light outlet 10c. In the direction from the light inlet 10b to the light outlet 10c, the peripheral surface 95 may extend in a direction other than toward the light guide cavity 10a.

An included angle between a central line L2 of the light guide cavity 10a and a contour line L1 obtained by intersecting the light guide cavity 10a with a cross-section passing through the central line L2 may be greater than or equal to 10 degrees and less than or equal to 45 degrees. In a case where the included angle is within this range, the direction of the light 331 from the lamp source may be changed within the light guide cavity 10a, thereby enabling the light 331 from the lamp source to be converged and mapped onto the same range on the ground with other lights 331, and achieving compactness of the housing 10. In a case where the included angle is less than 10 degrees, in the direction from the light inlet 10b to the light outlet 10c, the inclination angle of the peripheral surface 95 other than toward the light guide cavity 10a may be too small. Therefore, even after the light 331 is reflected by the cavity wall of the light guide cavity 10a, the emission direction of a portion of the light 331 may not differ much from the original emission direction, and the portion of the light 331 may still be displayed outside the range of the displayed light spot when mapped onto the ground. In a case where the included angle is greater than 45 degrees, the volume of the light guide cavity 10a may become too large, resulting in an overall volume of the housing 10 being too large. Therefore, it is impossible to achieve the compactness of the indicator lamp assembly 100, and the indicator lamp assembly 100 may occupy too much installation space in the door 200. In some examples, the included angle may be 10 degrees, 15 degrees, 20 degrees, 25 degrees, 30 degrees, 35 degrees, 40 degrees, or 45 degrees, etc., which is not limited in the present disclosure.

In some embodiments, as further shown in FIG. 2, a spacing L3 may be formed between the light emitting surface 93 of the light guide pillar 90 and the light inlet 10b. That is, the light guide pillar 90 may not be inserted into the light guide cavity 10a through the light inlet 10b. Thus, without the need for the light guide cavity 10a to allow or enable the insertion of the light guide pillar 90, it may not necessary to expand the volume of the light guide cavity 10a according to the volume of the light guide pillar 90. In this way, the volume of the housing 10 may be reduced, thereby achieving a compact design of the indicator lamp assembly 100.

The spacing L3 may be less than or equal to 9 mm. In this way, the light 331 may be transmitted from the light emitting surface 93 of the light guide pillar 90 to the light inlet 10b of the light guide cavity 10a with minimal loss, and the loss of the light 331 may be reduced, so that the displayed light spot presented on the ground may have uniform overall brightness. In a case where the spacing L3 is greater than 9 mm, the loss of the light 331 during the transmission between the light emitting surface 93 of the light guide pillar 90 and the light inlet 10b may become excessive. In some examples, the spacing L3 may be 1 mm, 3 mm, 5 mm, 7 mm, or 9 mm, etc., which is not limited in the present disclosure.

Of course, in other structural forms, the light guide pillar 90 may be inserted into the light guide cavity 10a through the light inlet 10b. In this case, the light emitting surface 93 may be located within the light guide cavity 10a, and during the transmission of the light 331, the loss of the light 331 may be reduced, which is not limited in the present disclosure.

A distance between the light emitting surface 93 and a focal plane on a light inlet side or light incident side of the convex lens 70 may be 20 mm to 50 mm. In a case where the distance is within this range, the area of the displayed light spot finally presented on the ground may be moderate, and the length of the housing 10 may be not too long. Based on the principle of plane imaging, in a case where the distance is less than 20 mm, the distance from the light emitting surface 93 to the focal plane of the convex lens 70 may be too close/short, so that the area of the displayed light spot finally presented on the ground may be too large, and the displayed light spot may occupy too much area on the ground. In a case where the spacing L3 is greater than 50 mm, the distance from the light emitting surface 93 to the focal plane of the convex lens 70 may be too far/long, so that the area of the displayed light spot finally presented on the ground may be too small, making it inconvenient for the users to observe the displayed light spot. Further, the overall length of the housing 10 may increase, thereby failing to achieve a compact design of the indicator lamp assembly 100. In some examples, the distance may be 20 mm, 30 mm, 40 mm, or 50 mm, etc., which is not limited in the present disclosure.

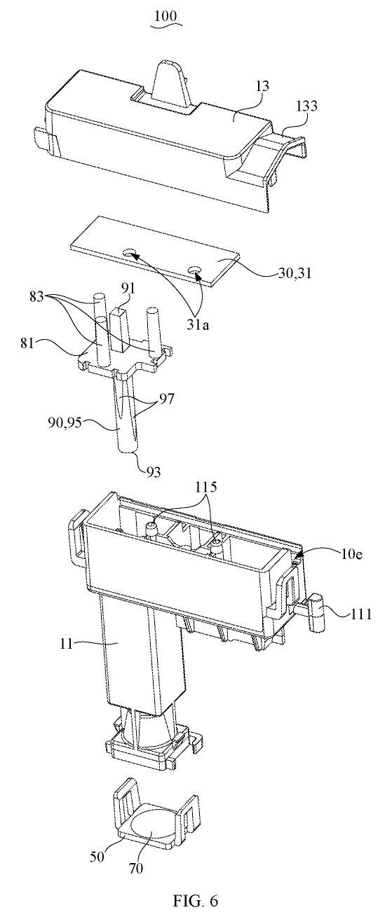

As shown in FIGS. 4 to 6, in one structural form, a plurality of inclined surfaces 97 may be formed on the peripheral surface 95. The plurality of inclined surfaces 97 may be arranged at intervals in a peripheral direction of the light guide pillar 90. The inclined surfaces 97 may extend from the light incident surface 91 toward the light emitting surface 93. An end of each of the inclined surfaces 97 facing the light incident surface 91 may be disposed closer to a center of the light guide pillar 90 than an end of each of the inclined surfaces 97 facing the light emitting surface 93.

In a case where the light 331 is transmitted inside the light guide pillar 90, due to regular reflection inside the light guide pillar 90, a portion of the light 331 may present small light spots within the displayed light spot, thereby affecting the display effect of the displayed light spot. With this configuration, the irregular inclined surfaces 97 may interrupt the regular reflection of the portion of the light 331 inside the light guide pillar 90, thereby reducing the possibility of generation of the small light spot and improving the display effect of the displayed light spot. In the exemplarily shown solution, the number of the inclined surfaces 97 may be four, and the four inclined surfaces 97 may be arranged at intervals in the peripheral direction of the light guide pillar 90 to achieve interruption of the regular reflection of the light 331 inside the light guide pillar 90 in the peripheral direction. Of course, the number of the inclined surfaces 97 may also be two, four, or five, etc., which is not limited in the present disclosure.

The above content, from the configurations of the lamp source 33, the convex lens 70, and the light guide pillar 90, describes that the displayed light spot projected by the indicator lamp assembly 100 of some embodiments of the present disclosure on the ground may have a good display effect. On this basis, from the perspective of facilitating the disassembly and assembly of the housing 10, as shown in FIGS. 4 to 6, the housing 10 of some embodiments of the present disclosure may include a housing body 11 and a housing cover 13. The housing body 11 may be hollow and have the light guide cavity 10a. The housing cover 13 may cover an end of the housing body 11 and cooperate with the housing body 11 to have the mounting cavity 10d. The housing cover 13 and the housing body 11 may together enclose and have the wire hole 10e. During the actual disassembly and assembly, the housing cover 13 may be disassembled from an end of the housing body 11, or the housing cover 13 may be covered on the end of the housing body 11. Thus, the disassembly and assembly of the housing cover 13 are convenient, facilitating maintenance personnel or users to maintain the lamp source assembly 30 and the light guide pillar 90 located in the mounting cavity 10d.

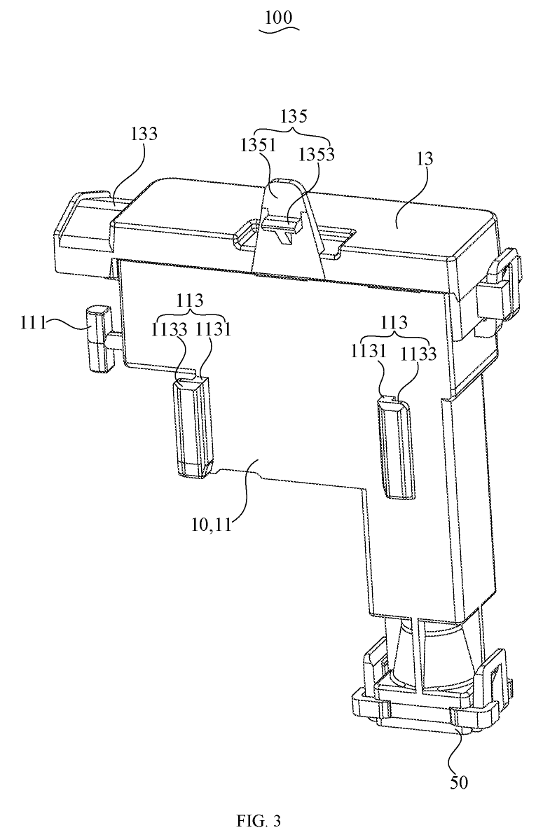

As shown in FIG. 3, in some embodiments of the present disclosure, a first engaging member or a snap fastener may be arranged at an outer side of the housing cover 13. A first engaging groove or a snap groove may be formed on an outer side of the housing body 11. The housing cover 13 may be covered on an end of the housing body 11 through the engagement between the first engaging member and the first engaging groove. On this basis, a first limiting portion may be arranged at the outer side of the housing cover 13. The first limiting portion may be disposed adjacent to the first engaging member. In a case where the first engaging member and the first engaging groove are in a snapped state, an outer surface of the housing body 11 which is configured with the first engaging groove may be limited by the first limiting portion, so that it is possible to reduce occurrence of the disengagement of the first engaging member from the first engaging groove, thereby improving the connection stability between the housing cover 13 and the housing body 11.

To further improve the connection stability between the housing cover 13 and the housing body 11, the number of the first engaging members and the first engaging grooves may be at least two, and the first engaging members and the first engaging grooves correspond one-to-one. The first engaging members may be arranged at two opposite sides of the housing cover 13 along a length direction of the housing 10.

During the actual use, in a case where the wire passes through the wire hole 10e, a part of wire may be exposed outside the mounting cavity 10d. It is possible that liquids such as water droplets or contaminants may fall from the cabinet. It is also possible that the liquid may fall from the tableware when the user loads the tableware into the washing cavity. When the liquid falls, in a case where the liquid falls on the wire of the wire exposed outside the mounting cavity 10d, the liquid may flow along the wire to a terminal of the wire, causing damage to the terminal and creating an electrical hazard.

Regarding the above issues, as shown in FIGS. 3 to 4, a water block member 133 may be arranged at the outer side of the housing cover 13 of the housing 10. The water block member 133 may be located above the wire hole 10e. With this configuration, the water block member 133 may block the liquid from flowing toward the wire and guide the liquid to a position outside the wire. In this way, it is possible to reduce the risk that the liquid flows towards the wires, thereby prolonging the service life of the indicator lamp assembly 100, and ensuring the electrical safety when the user uses the dishwasher.

Further, the water block member 133 may include a first water block section, a middle section, and a second water block section connected in sequence. The first water block section and the second water block section may be inclined downward in a thickness direction of the housing 10. Thus, the liquid may be guided to the ground, thereby reducing the occurrence of the liquid remaining on the water block member, keeping the water block member 133 dry. In this way, the water block member 133 is less likely to develop mold or breed bacteria due to dampness. Moreover, with this configuration, it is possible to reduce the interference of the water block member 133 with the structure of the first engaging groove of the housing body 11, thereby achieving avoidance, and reserving space for the connection between the first engaging member and the first engaging groove, facilitating operation of the maintenance personnel or the user.

To further reducing the occurrence of the liquid flowing towards the wire, the water block member 133 may further include a third water blocking section. The third water block section may be connected to a side cooperatively formed by the first water block section, the middle section, and the second water block section. The third water block section may extend in a height direction of the housing 10. Therefore, it is possible to block the liquid from flowing toward the wire from the side cooperatively formed by the first water block section, the middle section, and the second water block section.

In some structural forms, as shown in FIGS. 3 to 5, a wire winding member 111 may be arranged at the outer side of the housing body 11 of the housing 10. The wire winding member 111 may be disposed adjacent to the wire hole 10e. In a case where the length of the wire is too long, the wire routing may be messy, and a part of the wire may sag, thereby affecting the electrical safety and the aesthetics of the indicator lamp assembly 100. Therefore, with the configuration of the wire winding member 111, the part of the wire may be wound around the wire winding member 111, reducing the occurrence of messy wire routing and sagging.

In some embodiments, the wire winding member 111 may include a winding post and a limiting post. An end of the winding post may be connected to the outer side of the housing body 11 of the housing 10. Another opposite end of the winding post may be connected to the limiting post. An angle is formed between an extension direction of the winding post and an extension direction of the limiting post. The winding post may allow a part of the wire to be wound around it. The limiting post may be configured to stop the wire wound around the winding post to reduce the occurrence of the fall-off of the wire.

In some embodiments, as shown in FIGS. 4 to 6, the indicator lamp assembly 100 may further include a fixation frame 80. The fixation frame 80 may be fixed to an outer periphery of the light guide pillar 90. The fixation frame 80 may be connected to the housing 10 and abut against the circuit board 31. In this way, the circuit board 31 may be relatively fixed to the housing 10. The fixation frame 80 may have a through hole, and the light guide pillar 90 may pass through the through hole, so that the fixation frame 80 may be fixed to the outer periphery of the light guide pillar 90. Moreover, the fixation frame 80 may abut against the circuit board 31, so that the circuit board 31 may be more stably or securely fixed in the mounting cavity 10d, and the circuit board 31 may maintain a relatively fixed position with respect to the housing 10. Thus, during the actual operation, even in a case where the body causes the door 200 to shake during operation, causing the indicator lamp assembly 100 to also shake, the possibility of relative movement between the circuit board 31 and the housing 10 may be reduced in some embodiments of the present disclosure.

Further, the fixation frame 80 may include a fixation plate 81 and a plurality of support rods 83 connected to the fixation plate 81. The plurality of support rods 83 may be arranged around or surround the light guide pillar 90 and the fixation plate 81 may be fixedly connected to the housing body 11 of the housing 10. The plurality of support rods 83 may press the circuit board 31 against the housing 10. With this configuration, the circuit board 31 may be pressed against the housing cover 13 of the housing 10 through the plurality of support rods 83, thereby achieving the effect of abutting against the circuit board 31 in the peripheral direction, further improving the stability of the circuit board 31 when fixed in the mounting cavity 10d. The number of the support rods 83 may be two, three, or four, etc., which is not limited in the present disclosure.

From the perspective of facilitating the fixation of the fixation plate 81 in the mounting cavity 10d, a fixing groove may be formed on a side plate surface of the fixation plate 81. A fixing rib may be arranged at a cavity wall surface of the mounting cavity 10d. The fixing rib may be fixed in the fixing groove, so that the fixation plate 81 may engaged with the cavity wall surface of the mounting cavity 10d. In this way, the positional accuracy of the light guide pillar 90 within the mounting cavity 10d may be ensured, so that the light guide pillar 90 may accurately guide the light 331 emitted by the lamp source 33 to the light inlet 10b of the light guide cavity 10a.

In some embodiments, as shown in FIGS. 2 and 4, a positioning column 115 may be arranged at the housing body 11 of the housing 10. The circuit board 31 may have a positioning hole 31a. The positioning column 115 may be inserted in/engaged with the positioning hole 31a. Through the positioning cooperation between the positioning column 115 and the positioning hole 31a, the circuit board 31 may be accurately fixed in the mounting cavity 10d, that is, the position of the lamp source 33 mounted at the circuit board 31 within the mounting cavity 10d may be accurate, so that the lamp source 33 may be arranged directly opposite to the light incident surface 91 of the light guide pillar 90. Besides, the positioning column 115 may support the circuit board 31, so that the circuit board 31 may be fixed in the mounting cavity 10d.

Further, a stop rib 131 may be arranged at the housing cover 13 of the housing 10. The stop rib 131 may be configured to abut against the circuit board 31 to restrict the circuit board 31 from moving relative to the positioning column 115 and disengaging from the positioning column 115. With this configuration, the stability of the circuit board 31 fixed in the mounting cavity 10d may be further improved, thereby reducing the occurrence of the shifting or fall-off of the circuit board 31 due to the disengagement of the circuit board 31 from the positioning column 115.

In some structural forms, the indicator lamp assembly 100 may further include a mounting bracket 50. The mounting bracket 50 may be fixed to the housing body 11 of the housing 10. The mounting bracket 50 may be connected to the housing body 11 of the housing 10 by engagement / snap-fitting, bonding, threaded connection, etc.

The convex lens 70 may be mounted at the mounting bracket 50 and cover the light outlet 10c. With this configuration, the convex lens 70 may be indirectly fixed to the housing body 11 of the housing 10 through the mounting bracket 50, enabling convenient installation and stable connection. Moreover, in a case where the convex lens 70 is disposed at the light outlet 10c and covers the light outlet 10c, there may be no spacing between the convex lens 70 and the light outlet 10c, or the spacing is small, thereby reducing the overall length of the indicator lamp assembly 100 and achieving a compact design of the indicator lamp assembly 100.

Further, the mounting bracket 50 may include a bracket body and two connection legs arranged at two opposite sides of the bracket body, respectively. The convex lens 70 may be mounted at the bracket body. The two connection legs may be engaged with two opposite sides of the housing body 11 of the housing 10, respectively, thereby improving connection stability while facilitating disassembly.

In some embodiments, the mounting member 110 may be a sliding buckle arranged at an outer side of the housing 10. The connection member 210 may be a slide groove formed on the outer wall surface of the door 200. The sliding buckle may be connected to the slide groove. Therefore, the housing 10 may be fixedly connected to the door 200. Through the cooperation between the sliding buckle and the slide groove, the housing 10 may be fixed to the door 200 with a simple structure and quick disassembly and assembly. Of course, the connection between the housing 10 and the door 200 may also be achieved by bonding, magnetic attraction connection, threaded connection, etc., which is not limited in the present disclosure.

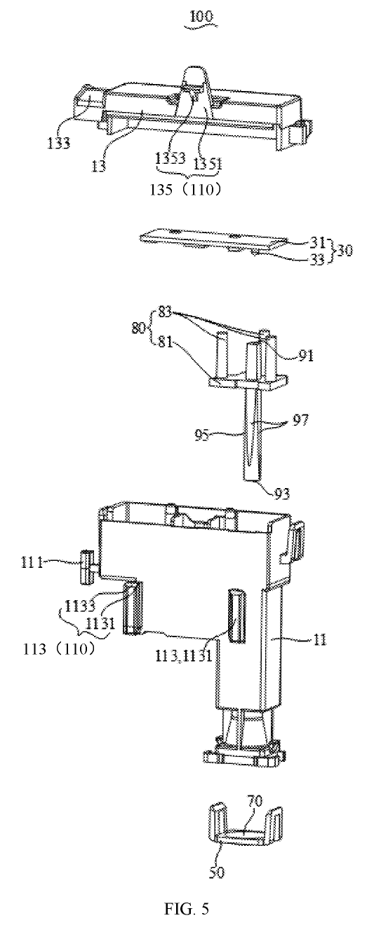

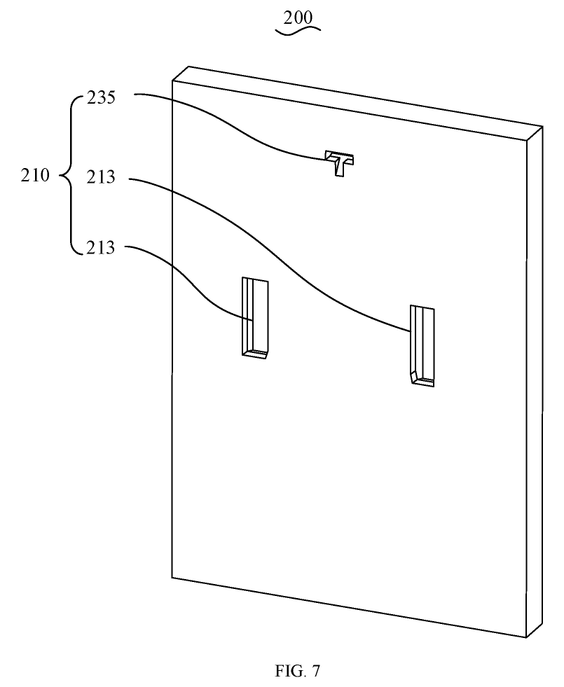

As further shown in FIGS. 5 and 7, the sliding buckle may include at least one of a first sliding buckle 135 or a second sliding buckle 113. The slide groove may include at least one of a first slide groove 235 or a second slide groove 213. The first sliding buckle 135 and the second sliding buckle 113 may be arranged at intervals in the height direction of the housing 10. Thus, the connection stability between the housing 10 and the door 200 may be improved in the height direction of the housing 10.

The first sliding buckle 135 may include an elastic arm 1351 and an engagement member 1353. An end of the elastic arm 1351 may be connected to the outer side of the housing cover 13 of the housing 10. Another end of the elastic arm 1351 may be connected to the engagement member 1353. The elastic arm 1351 may be elastically deformable to enable the engagement member 1353 to be engaged into the first slide groove 235. Thus, by operating the elastic arm 1351, the elastic arm 1351 may be elastically deformed to facilitate the engagement member 1353 to approach or move away from the first slide groove 235, thereby achieving the engagement or disengagement of the engagement member 1353 with the first slide groove 235.

An outer surface of the housing cover 13 may include a recess. The elastic arm 1351 may be connected to a bottom wall of the recess. In this way, the elastic arm 1351 may have better elastic deformation by extending the length of the elastic arm 1351, thereby facilitating the engagement member 1353 being close to or away from the first slide groove 235.

The second sliding buckle 113 may include a connection section 1131 and an engagement section 1133 arranged at an angle from the connection section 1131. An end of the connection section 1131 may be connected to the outer side of the housing body 11 of the housing 10, and another end of the connection section 1131 may be connected to the engagement section 1133. The engagement section 1133 may be engaged with the second slide groove 213. The number of the second sliding buckles 113 may be two. The number of the second slide grooves 213 may correspond to the number of the second sliding buckles 113, and the two adjacent engagement sections 1133 may extend away from each other along the length direction of the housing 10. That is, a number of the second slide grooves 213 is two. With this configuration, in a case where both engagement sections 1133 are engaged in the corresponding second slide grooves 213, in an assembled state, one engagement section 1133 may stop the other engagement section 1133 from moving in a direction opposite to the direction in which the other engagement section 1133 is snapped into the second slide groove 213, thereby ensuring connection stability.

During actual assembly, the two second sliding buckles 113 may first be engaged with the corresponding two slide grooves. In this way, preliminary fixation between the housing 10 and the door 200 may be achieved, and the relative positions between the housing 10 and the door 200 may be determined. At this time, by pressing the elastic arm 1351, the engagement member 1353 of the first sliding buckle 135 may be engaged in the first slide groove 235, thereby achieving final fixed connection between the housing 10 and the door 200. The operation may be convenient, and the connection may be stable.

In the drawings, the same or similar reference numerals correspond to the same or similar components. In the description of the present disclosure, it should be understood that terms such as “upper,” “lower,” “left,” and “right,” etc. indicating directions or positions are based on the directions or positions shown in the drawings, solely for the purpose of facilitating the description of the present disclosure and simplifying the description, and are not intended to indicate or imply that the devices or elements referred to must have a specific orientation, be constructed in a specific orientation, or operate in a specific orientation. Therefore, the terms to describe positional relationships in the drawings are provided for illustrative purposes only and should not be construed as limiting the scope of the present disclosure. For those skilled in the art, the specific meaning of the above terms may be understood based on the specific circumstances.

The above is merely some embodiments of the present disclosure and is not intended to limit the scope of the present disclosure. Any modifications, equivalent replacements, and improvements made within the spirit and principles of the present disclosure should be included within the scope of the present disclosure.

1. An indicator lamp assembly comprising:
a housing, having a light guide cavity including a light inlet and a light outlet, an inner diameter of the light guide cavity gradually increasing in a direction from the light inlet to the light outlet;
a lamp source assembly, including a circuit board fixed to the housing and a lamp source mounted at the circuit board;
a convex lens, fixed to the housing and disposed at the light outlet; and
a light guide pillar, fixed to the housing and located between the lamp source and the convex lens, the light guide pillar being configured to guide light emitted by the lamp source to the light inlet, and a portion of the light being reflected by a cavity wall of the light guide cavity and further emitted to the convex lens.

2. The indicator lamp assembly according to claim 1, wherein:
a contour of the light guide cavity is configured as a frustum; and
an included angle between a central line of the light guide cavity and a contour line obtained by intersecting the light guide cavity with a cross-section passing through the central line is greater than or equal to 10 degrees and less than or equal to 45 degrees.

3. The indicator lamp assembly according to claim 1, wherein the light guide pillar includes a light emitting surface facing the light inlet, a spacing is formed between the light emitting surface and the light inlet, and the spacing is less than or equal to 9 mm.

4. The indicator lamp assembly according to claim 1, wherein the light guide pillar is inserted into the light guide cavity through the light inlet.

5. The indicator lamp assembly according to claim 1, wherein the light guide pillar further includes a light emitting surface facing the light inlet, and a distance between the light emitting surface and a focal plane of the convex lens located on a light incident side of the convex lens is 20 mm to 50 mm.

6. The indicator lamp assembly according to claim 1, wherein the housing further has a mounting cavity in communication with the light guide cavity, and the lamp source assembly and the light guide pillar are fixed in the mounting cavity.

7. The indicator lamp assembly according to claim 6, wherein the housing includes a housing body and a housing cover, the housing body is hollow and has the light guide cavity, and the housing cover covers an end of the housing body and cooperates with the housing body to form the mounting cavity.

8. The indicator lamp assembly according to claim 7, wherein a stop rib is arranged at the housing cover of the housing and configured to abut against the circuit board.

9. The indicator lamp assembly according to claim 6, wherein the housing further has a wire hole in communication with the mounting cavity, the wire hole is configured for a wire connected to the circuit board to pass through, a water block member is arranged at an outer side of the housing, and the water block member is located above the wire hole.

10. The indicator lamp assembly according to claim 9, wherein a wire winding member is further arranged at an outer side of the housing, and the wire winding member is disposed adjacent to the wire hole.

11. The indicator lamp assembly according to claim 1, wherein:
the light guide pillar includes:
a light incident surface on an end in a length direction of the light guide pillar;
a light emitting surface on another end in the length direction of the light guide pillar; and
a peripheral surface connected between the light incident surface and the light emitting surface; and
a plurality of inclined surfaces are formed on the peripheral surface and arranged at intervals in a peripheral direction of the light guide pillar, the plurality of inclined surfaces extend from the light incident surface toward the light emitting surface, and an end of each of the plurality of inclined surfaces facing the light incident surface is disposed closer to a center of the light guide pillar than an end of each of the plurality of inclined surfaces facing the light emitting surface.

12. The indicator lamp assembly according to claim 1, further comprising:
a fixation frame, fixed to an outer periphery of the light guide pillar, connected to the housing, and abutting against the circuit board;
wherein the circuit board is fixed to the housing.

13. The indicator lamp assembly according to claim 12, wherein the fixation frame includes a fixation plate and a plurality of support rods connected to the fixation plate and arranged around or surrounding an outer side of the light guide pillar, the fixation plate is fixedly connected to the housing, and the plurality of support rods are configured to press the circuit board against the housing.

14. The indicator lamp assembly according to claim 1, wherein the housing further includes a positioning column, and the circuit board has a positioning hole engaged with the positioning column.

15. The indicator lamp assembly according to claim 1, further comprising:
a mounting bracket, fixed to the housing;
wherein the convex lens is mounted at the mounting bracket and covers the light outlet.

16. The indicator lamp assembly according to claim 1, wherein:
the lamp source is a multi-color LED light; and/or
the convex lens is biconvex lens.

17. A door assembly comprising:
a door, a connection member being arranged at an outer wall surface of the door; and
an indicator lamp assembly including:
a housing, having a light guide cavity including a light inlet and a light outlet, an inner diameter of the light guide cavity gradually increasing in a direction from the light inlet to the light outlet;
a lamp source assembly, including a circuit board fixed to the housing and a lamp source mounted at the circuit board;
a convex lens, fixed to the housing and disposed at the light outlet; and
a light guide pillar, fixed to the housing and located between the lamp source and the convex lens, the light guide pillar being configured to guide light emitted by the lamp source to the light inlet, and a portion of the light being reflected by a cavity wall of the light guide cavity and further emitted to the convex lens;
wherein a mounting member is arranged at the housing and fixedly connected to the connection member.

18. The door assembly according to claim 17, wherein:
the mounting member includes a sliding buckle arranged at an outer side of the housing, and the connection member includes a slide groove formed on the outer wall surface of the door; and
the sliding buckle is connected to the slide groove, and the housing is fixedly connected to the door.

19. The door assembly according to claim 18, wherein:
the sliding buckle includes at least one of a first sliding buckle or at least two second sliding buckles, and the slide groove includes at least one of a first slide groove or at least two second slide grooves;
the first sliding buckle includes an elastic arm and an engagement member, an end of the elastic arm is connected to the outer side of the housing, another end of the elastic arm is connected to the engagement member, and the elastic arm is elastically deformable to enable the engagement member to be engaged into the first slide groove;
each of the second sliding buckle includes a connection section and an engagement section arranged at an angle to the connection section and cooperatively engaged with a corresponding one of the at least two second slide grooves, an end of the connection section is connected to the outer side of the housing, another end of the connection section is connected to the engagement section, and two adjacent engagement sections of two of the at least two second sliding buckles extend away from each other along a length direction of the housing.

20. A dishwasher comprising:
a body; and
a door assembly including:
a door, mounted at the body, a connection member being arranged at an outer wall surface of the door; and
an indicator lamp assembly including:
a housing, having a light guide cavity including a light inlet and a light outlet, an inner diameter of the light guide cavity gradually increasing in a direction from the light inlet to the light outlet;
a lamp source assembly, including a circuit board fixed to the housing and a lamp source mounted at the circuit board;
a convex lens, fixed to the housing and disposed at the light outlet; and
a light guide pillar, fixed to the housing and located between the lamp source and the convex lens, the light guide pillar being configured to guide light emitted by the lamp source to the light inlet, and a portion of the light being reflected by a cavity wall of the light guide cavity and further emitted to the convex lens;
wherein a mounting member is arranged at the housing and fixedly connected to the connection member.
